(19) United States
(12) Patent Application Publication
(10) Pub. No.: US 2005/0242677 A1
(43) Pub. Date: Nov. 3, 2005

(54) Electric motor, electric power steering apparatus equipped with the motor, and wire winding method for the motor

(75) Inventors: Shigemitsu Akutsu, Wako-shi (JP); Hirofumi Atarashi, Wako-shi (JP); Takashi Kuribayashi, Wako-shi (JP); Hiroyuki Baba, Wako-shi (JP); Takeo Fukuda, Wako-shi (JP); Mitsuo Nakazumi, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 11/109,524

(22) Filed: Apr. 18, 2005

(30) Foreign Application Priority Data
Apr. 28, 2004 (JP) 2004-134254

(51) Int. Cl. H02K 1/00; H02K 3/00; H02K 1/12

(52) U.S. Cl. 310/179; 310/216

(57) ABSTRACT

Coil windings are provided on each predetermined pair of adjoining tooth portions in a 8-like configuration by: winding a lead wire around one of the tooth portions a predetermined number of times, starting from a point adjacent to one side portion of a teeth-adjoining region; then winding the lead wire around the other tooth portion the same number of times, starting from a point adjacent to the other side portion of the teeth-adjoining region opposite from the one side portion; and terminating the winding of the lead wire at a point adjacent to the teeth-adjoining region.

### FIELD OF THE INVENTION

The present invention relates to electric motors, electric power steering apparatus equipped with electric motors, and wire winding methods for electric motors.

### BACKGROUND OF THE INVENTION

As well known, the electric power steering apparatus are steering assisting apparatus which are constructed to activate an electric motor (steering assisting motor) as a human driver manually operates a steering wheel during travel of a motor vehicle, to thereby assist the driver's manual steering effort. In such electric power steering apparatus, the steering assisting motor, which provides a steering assist force or torque, is controlled by a motor control section on the basis of a steering torque signal generated by a steering torque detection section detecting steering torque that is produced on the steering shaft by driver's operation of the steering wheel and a vehicle velocity signal generated by a vehicle velocity detection section detecting a traveling velocity of the vehicle, so as to reduce the manual steering force to be applied by the human driver.

Japanese Patent Application Laid-Open Publication No. 2001-275325 discloses an example of an electric power steering apparatus for a vehicle, where steering torque applied to the steering wheel is delivered to an output shaft of a rack and pinion mechanism and steering assist torque produced by the electric motor in accordance with the steering torque is delivered to a pinion shaft via a frictional transmission mechanism and worm gear mechanism. Thus, road wheels of the vehicle are steered via the rack and pinion mechanism.

The electric power steering apparatus disclosed in the above-mentioned No. 2001-275325 publication is designed to: impart a good steering feel by minimizing effects of undesired variation in the steering assist torque that tends to be caused by the motor when the vehicle should travel straight with the motor kept deenergized; and enhance the controllability of the vehicle by efficiently enhancing the output performance of the motor. For these purposes, the electric motor comprises an annular outer stator having windings (i.e., coil windings) provided on nine or N (N represents an integer multiple of nine) circumferentially-arranged poles, and an inner rotor located inwardly of the outer stator and including circumferentially-arranged permanent magnets of eight poles. The coil windings on the stator are connected in such a fashion as to be driven by three-phase electric currents.

In one embodiment of the electric motor disclosed in the No. 2001-275325 publication, each connecting line, which serially connects the adjoining coil windings of a same phase, extends from one of the coil windings to the next coil winding, adjoining the one coil winding, where it arcuately extends around (i.e., substantially straddles) a considerable or relatively great part of the outer periphery of the next coil winding to reach a point of the next coil winding remote from the one coil winding (rather than a point of the next coil winding close to the one coil winding). The extra length substantially straddling the considerable part of the outer periphery of the next coil winding as noted above would considerably increase the total length of the connecting line. In another embodiment of the electric motor, each connecting line serially connects the coil windings of a same phase that do not adjoin each other; in this case, however, the connecting line per phase has an increased length because the connecting line straddles the coil winding of at least one other phase.

FIG. 12 is a diagram showing an example of a conventional wire winding technique employed in a known electric motor having, for example, twelve tooth portions on its stator; in the figure, the winding technique is shown only in relation to a pair of adjoining tooth portions 100 and 103 corresponding to one of three phases (e.g., U phase); although not specifically shown, the same winding technique is of course applied to the other phases. In this case, a lead wire is wound, starting from a winding start point 101, around one of the adjoining tooth portions 100 a plurality of times (i.e., a plurality of turns), and then cut at a winding end point 102. Similarly, another lead wire is wound, starting from a winding start point 104, around the other of the adjoining tooth portions 103 a plurality of times (i.e., a plurality of turns) and then cut at a winding end point 105. In this manner, one lead wire is wound around each of the adjoining tooth portions, and the respective winding start points and end points of the coil windings on the tooth portions are connected by connecting lines directly or via terminals. This winding scheme is suitable for formation of the coil winding per tooth portion. However, this winding technique requires an intermediary connecting line interconnecting the respective winding end points 102 and 105 of the coil windings. Thus, crossover wire portion has to have a long length, which would result in an increased ineffective wire length. Further, because the wire connections and center points are located on the same side of the tooth portions, a great space is required.

FIG. 13 shows another example of a conventional wire winding technique only in relation to a pair of adjoining tooth portions 106 and 109 corresponding to one of three phases (e.g., U phase). In this case, a lead wire is wound, starting from a winding start point 107, around one of the adjoining tooth portions 106 a plurality of times (i.e., turns) and then continuously drawn, without being cut at a winding end point 108, to the next tooth portion 109, around which the lead wire is wound the same plurality of times as around the tooth portion 106. After that, the lead wire is cut at a winding end point 110. In this manner, the same lead wire is continuously wound on the two adjoining tooth portions 106 and 109, and then the winding start point 107 and winding end point 110 are connected by connecting lines directly or via terminals. In this case, predetermined air insulation layers 111 and 112 are provided between the coils of the lead wire, and an extra length of the lead wire required due to the provision of the air insulation layers 111 and 112 would result in an ineffective wire length. But, because the coil windings on the tooth portions 106 and 109 are of the same phase, no insulating distance is necessary in a region 113 where the two tooth portions 106 and 109 adjoin or face each other (hereinafter called “teeth-adjoining region” 113), and, fundamentally, no insulating distance is required in the teeth-adjoining region 113. Therefore, this wire winding technique can significantly reduce the ineffective wire length. However, in this case too, wire connections and center points are located on the same side of the tooth portions, a great space is required due to overlapping between the wire connections.

FIG. 14 is a schematic wiring diagram showing various coil windings in a conventional electric motor 120, of which section (a) shows six pairs of adjoining coil windings 123a-123l of twelve poles wound on tooth portions 122a-122l to provide three-phase (i.e., U-, V- and W-phase) winding units. More specifically, two pairs of the adjoining coil windings 123a, 123b and 123g, 123h are connected in series to provide the U-phase winding unit, other two pairs of the adjoining coil windings 123c, 123d and 123i, 123j are connected in series to provide the V-phase winding unit, and still other two pairs of the adjoining coil windings 123e, 123f and 123k, 123l are connected in series to provide the W-phase winding unit. As illustrated in section (b) of the figure, the respective one ends Uo, Vo and Wo are connected to a battery 124.

FIG. 15 is a wiring diagram showing wire connections and neutral lines of the coil windings 123a-123l. Terminal 125a of the coil winding 123a is connected via a connecting line 126a to a terminal U, a terminal 125b of the coil winding 123b is connected via a connecting line 126b to a terminal 125h of the coil winding 123h, and a terminal 125c of the coil winding 123c is connected via a connecting line 126c to a terminal 125j of the coil winding 123j. Further, a terminal 125d of the coil winding 123d is connected via a connecting line 126d to a terminal V, and a terminal 125e of the coil winding 123e is connected via a connecting line 126e to a terminal W. Furthermore, a terminal 125f of the coil winding 123f is connected via a connecting line 126f to a terminal 125l of the coil winding 123l, and a terminal 125g of the coil winding 123g is connected via a connecting line 126g to a terminal 125i of the coil winding 123i and terminal 125k of the coil winding 123k.

As seen in FIG. 15, the connecting lines 126b, 126f and 126g in the conventional motor overlap in a region 127 enclosed by an oval in the figure. Further, because the connecting lines 126a, 126b, 126c, 126d, 126e, 126f and 126g are all drawn to the upper side of the motor, the overall length of the motor would increase. Besides, layout and assembly of the components of the motor tend to be difficult.

### SUMMARY OF THE INVENTION

In view of the foregoing, it is an object of the present invention to provide an improved electric motor which is suitable for use in, for example, an electric power steering apparatus and which is small in size, easy to assemble and yet can output greater torque, as well as a novel wire winding method for the motor.

According to a first aspect of the present invention, there is provided an electric motor, which comprises: a stator having a plurality of tooth portions; a rotor provided for rotation in opposed relation to the distal end surfaces of the tooth portions; and coil windings provided on the plurality of tooth portions, the coil windings on each predetermined pair of the adjoining tooth portions being formed in an 8-like configuration by: winding a lead wire around one of the adjoining tooth portions a predetermined number of times, starting from a winding start point adjacent to one side portion of a teeth-adjoining region where the adjoining tooth portions face each other; then winding the lead wire around the other of the adjoining tooth portions the same predetermined number of times, starting from a winding start point adjacent to another side portion of the teeth-adjoining region that is located opposite from the one side portion of the teeth-adjoining region; and terminating the winding of the lead wire at a winding end point adjacent to the teeth-adjoining region.

According to a second aspect of the present invention, there is provided an electric motor, which comprises: a stator having a plurality of tooth portions; a rotor provided for rotation in opposed relation to the distal end surfaces of the tooth portions; coil windings provided on the plurality of tooth portions by winding a single lead wire around all of the plurality of tooth portions, the coil windings on each predetermined pair of the adjoining tooth portions being formed in an 8-like configuration by: winding the lead wire around one of the adjoining tooth portions a predetermined number of times, starting from a winding start point adjacent to one side portion of a teeth-adjoining region where the adjoining tooth portions face each other; winding the lead wire around other of the adjoining tooth portions the predetermined number of times, starting from a winding start point adjacent to another side portion of the teeth-adjoining region that is located opposite from the winding start point adjacent to the one side portion of the teeth-adjoining region; and terminating the lead wire at a winding end point adjacent to the teeth-adjoining region. The single lead wire is cut at a predetermined point thereof after having been continuously wound around all of the predetermined pairs of the tooth portions corresponding to a plurality of given phases.

According to a third aspect of the present invention, there is provided an electric power steering apparatus, which comprises: an electric motor for imparting steering assist force to a steering system, the electric motor being the electric motor arranged in the above-identified manner; a steering input torque detection section for detecting steering input torque to the steering system; and a target motor current calculation section for calculating target current to be applied to the electric motor, on the basis of at least the input detected via the steering torque detection section.

According to a fourth aspect of the present invention, there is provided a wire winding method for an electric motor, the electric motor including a stator having a plurality of tooth portions and a rotor provided for rotation in opposed relation to distal end surfaces of the tooth portions, the wire winding method comprising: a step of winding a single lead wire around each predetermined pair of adjoining the tooth portions in an 8-like configuration by: a) winding the lead wire around one of the adjoining tooth portions a predetermined number of times, starting from a point adjacent to one side portion of a teeth-adjoining region where the adjoining tooth portions face each other; b) then winding the lead wire around other of the adjoining tooth portions the predetermined number of times, starting from a point adjacent to another side portion of the teeth-adjoining region that is located opposite from the one side portion of the teeth-adjoining region; and c) then terminating winding of the lead wire at a point adjacent to the teeth-adjoining region; and a step of cutting the single lead wire at a predetermined point thereof after the lead wire has been continuously wound around all of the predetermined pairs of the adjoining tooth portions, corresponding to a plurality of given phases, by performing the step of winding for each of the given phases.

The first-aspect arrangements identified above can significantly reduce the crossover wire portion, reduce overlapping of the connecting lines and enhance the output torque of the motor. Further, layout and assembly of various components of the motor can be greatly facilitated. The second-aspect arrangements identified above can facilitate the formation of the coil windings. Further, the electric power steering apparatus equipped with the electric motor of the present invention can impart a steering assist force more appropriately, thereby improving a steering feel.

Furthermore, the wire winding method of the present invention can significantly reduce the crossover wire portion, reduce overlapping of the connecting lines and enhance the output torque of the motor.

### BRIEF DESCRIPTION OF THE DRAWINGS

Certain preferred embodiments of the present invention will hereinafter be described in detail, by way of example only, with reference to the accompanying drawings, in which:

FIG. 1 is a view showing a general setup of an electric power steering apparatus equipped with an electric motor of the present invention;

FIG. 2 is a view showing specific mechanical and electrical arrangements of the electric power steering apparatus;

FIG. 3 is a sectional view taken along the A-A line of FIG. 2;

FIG. 4 is a sectional view taken along the B-B line of FIG. 3;

FIG. 5 is a sectional view taken along the C-C line of FIG. 4, which shows a sectional construction of the electric motor;

FIG. 6 is a diagram schematically showing a first specific example of a wire winding technique employed in the electric motor of the present invention;

FIG. 7 is a diagram schematically showing a second specific example of the wire winding technique employed in the electric motor of the present invention;

FIGS. 8A and 8B are wiring diagrams of the entire electric motor of the present invention;

FIG. 9 is a wiring diagram showing wire connections and neutral lines of the coil windings in the electric motor of the present invention;

FIG. 10 is a wiring diagram of a second embodiment of the electric motor shown in FIG. 9;

FIG. 11 is a wiring diagram showing wire connections and neutral lines of the coil windings in the second embodiment of the electric motor;

FIG. 12 is a diagram showing a conventional wire winding technique employed in an electric motor,

FIG. 13 is a diagram showing another conventional wire winding technique employed in an electric motor;

FIG. 14 is a wiring diagram of a conventional electric motor; and

FIG. 15 is a wiring diagram showing wire connections and neutral lines of the coil windings in the conventional electric motor.

### DETAILED DESCRIPTION OF THE PREFERRED EMBODIMENTS

It should be appreciated that various constructions, shapes, sizes, positions, etc. explained below in relation to various embodiments of the present invention are just for illustrative purposes, and that the present invention is not limited to the embodiments described below and may be modified variously without departing from the scope indicated by the appended claims.

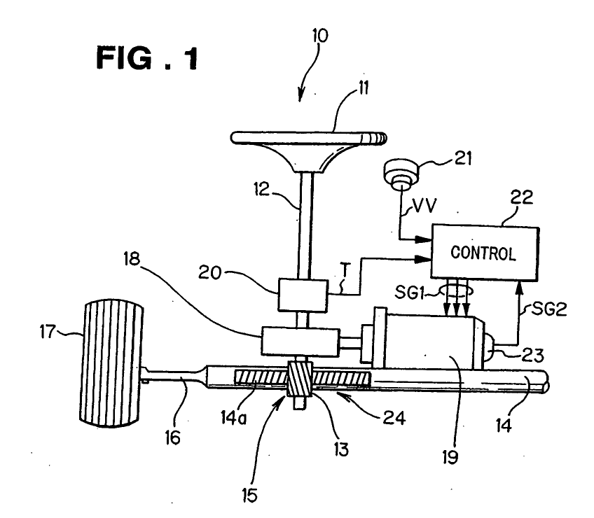

First, with reference to FIGS. 1 to 4, descriptions will be given about a general setup, specific mechanical and electrical arrangements and layout of electronic components of an electric power steering apparatus equipped with an electric motor of the present invention.

FIG. 1 is a view showing the general setup of the electric power steering apparatus 10, which is applied, for example, to a passenger vehicle. The electric power steering apparatus 10 is constructed to impart a steering assist force (steering assist torque) to a steering shaft 12 connected to a steering wheel 11 of the vehicle. The steering shaft 12 has an upper end connected to the steering wheel 11 and a lower end connected to a pinion gear 13. The pinion gear 13 meshes with a rack gear 14a formed on a rack shaft 14. The pinion gear 13 and rack gear 14a together constitute a rack and pinion mechanism 15. Tie rods 16 are provided at opposite ends of the rack shaft 14, and a front road wheel 17 is connected to the outer end of each of the tie rods 16.

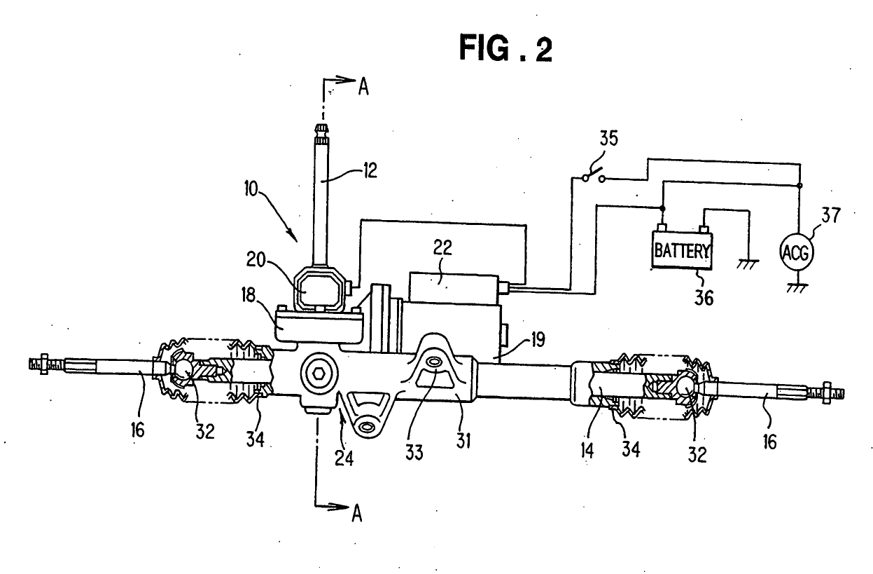

The electric motor 19, which is for example a brushless motor, generates a rotational force (torque) for assisting or supplementing steering torque applied manually through operation, by a human vehicle driver, of the steering wheel 11, and the thus-generated rotational force is transmitted via a power transmission mechanism 18 to the steering shaft 12. Steering torque detection section 20 is provided on the steering shaft 12. The steering torque detection section 20 detects the steering torque applied by the human driver of the vehicle operating the steering wheel 11. Reference numeral 21 represents a vehicle velocity detection section for detecting a traveling velocity of the vehicle, and 22 represents a control device implemented by a computer. On the basis of a steering torque signal T output from the steering torque detection section 20 and vehicle velocity signal VV output from the vehicle velocity detection section 21, the control device 22 generates drive control signals SG1 for controlling rotation of the motor 19. Rotational angle detection section 23, which is implemented for example by a resolver, is attached to the motor 19. Rotational angle signal SG2 output from the rotational angle detection section 23 is fed to the control device 22. The above-mentioned rack and pinion mechanism 15 is accommodated in a gearbox 24 (FIG. 2).

Namely, the electric power steering apparatus 10 is constructed by adding, to the construction of the conventional steering system, the above-mentioned steering torque detection section 20, vehicle velocity detection section 21, control device 22, motor 19 and power transmission mechanism 18.

As the driver operates the steering wheel 11 in order to change a traveling direction during travel of the vehicle, a rotational force based on the steering torque applied by the driver to the steering shaft 12 is converted via the rack and pinion mechanism 15 into axial linear movement of the rack shaft 14, which, via the tie rods 16, changes an operating direction of the front road wheels 17. During that time, the steering torque detection section 20, attached to the steering shaft 12, detects the steering torque applied by the driver via the steering wheel 11 and converts the detected steering torque into an electrical steering torque signal T, which is then supplied to the control device 22. The vehicle velocity detection section 21 detects the velocity of the vehicle and converts the detected vehicle velocity into an electrical vehicle velocity signal VV, which is also supplied to the control device 22.

The control device 22 generates motor currents Iu, Iv and Iw for driving the motor 19 on the basis of the supplied steering torque signal T and vehicle velocity signal VV. Specifically, the motor 19 is a three-phase motor driven by the A.C. motor currents Iu, Iv and Iw of three phases, i.e. U, V and W phases. Namely, the above-mentioned drive control signals SG1 are in the form of the three-phase motor currents Iu, Iv and Iw. The motor 19 is driven by such motor currents Iu, Iv and Iw to generate a steering assist force (steering assist torque) that acts on the steering shaft 12 via the power transmission mechanism 18. With the electric motor 19 driven in this manner, the steering force to be applied manually by the driver to the steering wheel 11 can be reduced.

FIG. 2 is a view showing mechanical and electric arrangements of the electric power steering apparatus 10. The rack shaft 14, whose left and right end portions are partly shown in section, is accommodated in a cylindrical housing 31 extending in a widthwise direction (left-and-right direction of FIG. 2) of the vehicle, and the rack shaft 14 is axially slidable in the cylindrical housing 31. Ball joints 32 are screwed onto the opposite ends of the rack shaft 14 projecting outwardly of the housing 31. The left and right tie rods 16 are coupled to the ball joints 32. The housing 31 has brackets 33 by which the housing 31 is attached to a body (not shown) of the vehicle, and stoppers 34 provided on its opposite ends.

In FIG. 2, reference numeral 35 represents an ignition switch, 36 a vehicle-mounted battery, and 37 an A.C. generator (ACG) attached to an engine (not shown) of the vehicle. By the vehicle engine, the A.C. generator 37 is caused to start generating electric power. Necessary electric power is supplied to the control device 22 from the battery 36 or A.C. generator 37. The control device 22 is attached to the motor 19.

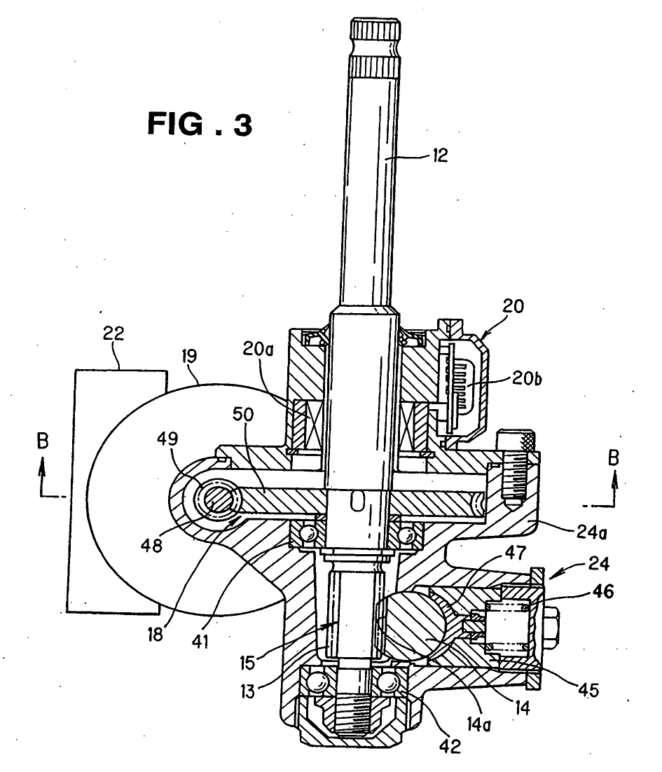

FIG. 3 is a sectional view, taken along the A-A lines of FIG. 2, which illustratively shows specific constructions of a steering-shaft support structure, steering torque detection section 20, power transmission mechanism 18 and rack and pinion mechanism 15, as well as layout of the electric motor 19 and control device 22.

In FIG. 3, the steering shaft 12 is rotatably supported, via two bearings 41 and 42, in a housing 24a forming the above-mentioned gearbox 24. The rack and pinion mechanism 15 and power transmission mechanism 18 are accommodated in the housing 24a, and the steering torque detection section 20 is attached to an upper portion of the housing 24a. The pinion 13, provided on a lower end portion of the steering shaft 12, is located between the two bearings 41 and 42. The rack shaft 14 is guided by a rack guide 45 and normally pressed against the pinion 13 by a pressing member 47 that is in turn resiliently biased by a compression spring 46. The power transmission mechanism 18 includes a worm gear 49 fixedly mounted on a transmission shaft 48 coupled to the output shaft of the motor 19, and a worm wheel 50 fixedly mounted on the pinion shaft 12. The steering torque detection section 20 includes a steering torque sensor 20a positioned around the steering shaft 12, and an electronic circuit section 20b for electronically processing a steering torque detection signal output from the steering torque sensor 20a.

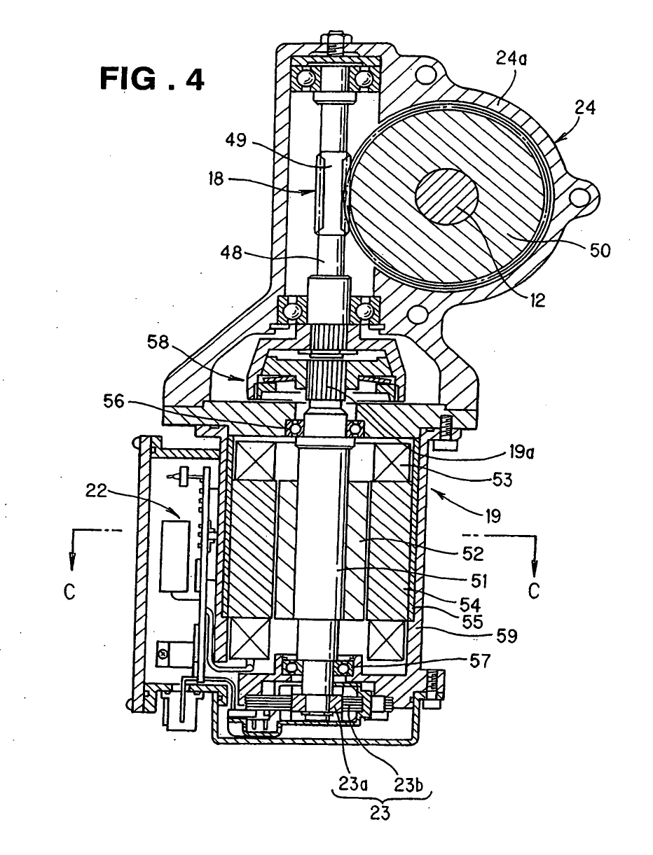

FIG. 4, which is a sectional view taken along the B-B line of FIG. 3, shows detailed inner constructions of the motor 19 and control device 22.

The motor 19 includes an inner rotor 52 having a plurality of permanent magnets fixedly mounted on a rotation shaft 51, and annular outer stators 54 and 55 positioned adjacent to and around the outer periphery of the inner rotor 52 and having coil windings 53 wound thereon. The rotation shaft 51 is rotatably supported via two bearings 56 and 57. One end portion of the rotation shaft 51 forms the output shaft 19a of the motor 19. The output shaft 19a of the motor 19 is coupled to the transmission shaft 48 so that the rotational force of the motor 19 can be transmitted to the transmission shaft 48 via a torque limiter 58.

The worm gear 49 is fixedly mounted on the transmission shaft 48 as noted above, and the worm wheel 50 meshing with the worm gear 49 is fixedly mounted on the steering shaft 12. The above-mentioned rotational angle detection section (rotational position detection section) 23 for detecting a rotational angle (rotational position) of the inner rotor 52 of the motor 19 is provided at a rear end portion of the rotation shaft 51. The rotational angle detection section 23 includes a rotating element 23a fixed to the rotation shaft 51, and a detecting element 23b for detecting a rotational angle of the rotating element 23a through magnetic action. For example, the rotational angle detection section 23 may comprise a resolver. The motor currents Iu, Iv and Iw, which are three-phase A.C. currents, are supplied to the coil windings 53 of the outer stators 54 and 55. The above-mentioned components of the motor 19 are positioned within a motor case 59.

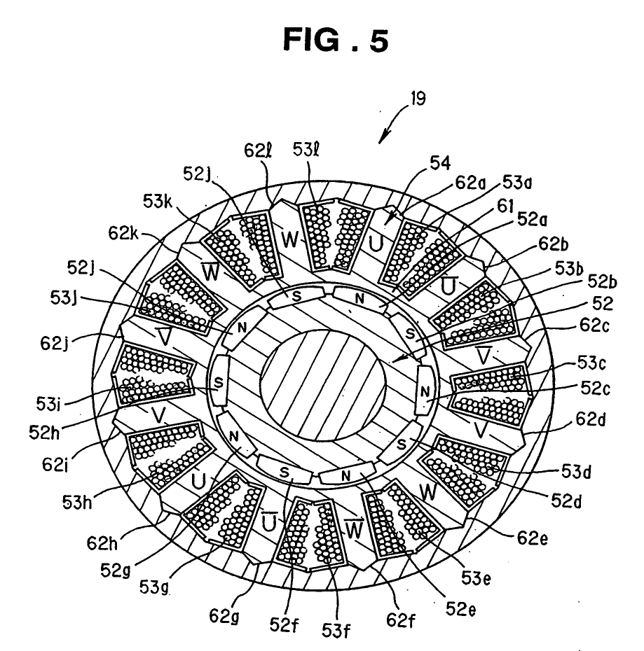

FIG. 5, which is a sectional view taken along the C-C line of FIG. 4, shows a sectional construction of the motor 19, from which illustration of the control device 22 is omitted. As shown, the outer stator 54 has twelve salient poles or tooth portions 62a-62l extending radially from an outer peripheral surface of a cylindrical portion 61 at equal circumferential pitches. The coil windings 53a-53l are wound on the twelve tooth portions 62a-62l to provide the U-, V- and W-phase winding units. Specifically, six pairs of the coil windings 53a, 53b; 53c, 53d; 53e, 53f, 53g, 53h; 53i, 53j; and 53k, 53l are wound on six pairs of adjoining tooth portions 63a, 63b; 63c, 63d; 63e, 63f; 63g, 63h; 63i, 63j; and 63k, 63l in such a manner that each of the U-, V- and W-phase winding units is provided on every third pairs of adjoining tooth portions.

The rotor 52 is a rotational member having ten permanent magnets 52a-52j arranged along the circumference thereof. These ten permanent magnets 52a-52j together constitute an annular or ring-shaped magnetic member that is magnetized in a radial direction (i.e., in an inward/outward direction between the inner and outer surfaces) of the rotor 52, and the permanent magnets 52a-52j are arranged in such a manner that N and S poles alternate in the circumferential direction.

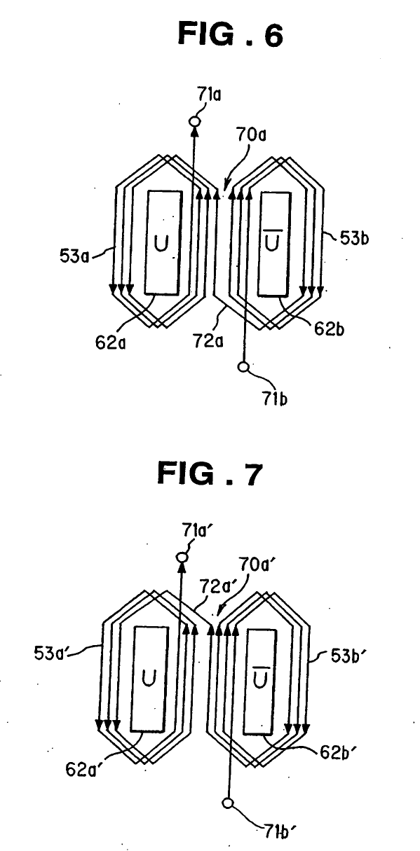

Now, with reference to FIG. 6, a description will be given about a first specific example of a coil winding technique employed in the embodiment of the electric motor of the present invention. When two coil windings 53a and 53b of the U phase, for example, are to be wound on a pair of two adjoining tooth portions 62a and 62b corresponding to one of three phases (U phase in the illustrated example), a lead wire is wound around one of the tooth portions 62b, starting from a winding start point 71b adjacent to one side portion (lower side portion in the figure) of a region 70a where the two adjoining tooth portions 62a and 62b face each other (hereinafter called “teeth-adjoining region” 70a). After the lead wire has been wound on the tooth portion 62b a predetermined number of times (i.e., predetermined turns), it is passed through the teeth-adjoining region 70a to adjacent to the other side portion (upper side portion in the figure) of the teeth-adjoining region 70a and then wound around the other tooth portion 62a the same predetermined number of times as around the tooth portion 62b, starting from a winding start point adjacent to the other side portion of the teeth-adjoining region 70a axially opposite from the winding start point 71b adjacent to the one side portion of the teeth-adjoining region 70a and terminating at a winding end point 71a adjacent to the other side portion of the teeth-adjoining region 70a. In this way, the lead wire is wound on the two adjoining tooth portions 62a and 62b in a generally “8” configuration, to provide a coil winding unit of the U phase. Although not specifically shown in FIG. 6, the same winding technique is applied to the remaining pairs of adjoining tooth portions to provide coil winding units of the three phases.

According to the above-described first specific example of the winding technique, the lead wire is continuously wound on each predetermined pair of the tooth portions. The output end of the lead wire (i.e., winding end point 71a on the center point side) is located axially opposite from the input end of the wire (i.e., winding start point 71b on the wire connection side). With this first specific example of the winding technique, a crossover wire portion 72a can be significantly reduced in length, so that an ineffective wire length can be minimized. Further, because this example can provide one extra turn between the two adjoining tooth portions while still securing appropriate insulating spaces with the other phases, it can effectively increase output torque of the motor. Further, because the winding start point 71b and winding end point 71a are located in axially-opposite directions, wire connections can be located dispersedly on the opposite sides (upper and lower sides in the figure) of the tooth portions, with the result that it is easy to secure a sufficient wiring space.

FIG. 7 shows a second specific example of the coil winding technique employed in the embodiment of the electric motor of the present invention. When two coil windings 53a′ and 53b′ of the U phase, for example, are to be wound on a pair of two adjoining tooth portions 62a′ and 62b′ corresponding to one of three phases (U phase in the illustrated example), a lead wire is wound around one of the tooth portions 62b′, starting from a winding start point 71b′ adjacent to one side portion (lower side portion in the figure) of a teeth-adjoining region 70a′. After the lead wire has been wound on the tooth portion 62b′ a predetermined number of times (i.e., predetermined turns), it is passed through the teeth-adjoining region 70a′ to adjacent to the other side portion (upper side portion in the figure) of the teeth-adjoining region 70a′ and then wound around the other tooth portion 62a′ the same predetermined number of times as around the tooth portion 62b′, starting from a winding start point adjacent to the other side portion of the teeth-adjoining region 70a axially opposite from the winding start point 71b′ and terminating at a winding end point 71a′ adjacent to the other side portion of the teeth-adjoining region 70a. In this way, the lead wire is wound on the two tooth portions 62a′ and 62b′ in a generally “8” configuration, to provide a coil winding unit of the U phase. In this example, however, a crossover wire portion 72a′ is located in a different position from the crossover wire portion 72a in the first specific example of FIG. 6.

Just as in the first specific example of the coil winding technique, the lead wire in the second specific example of the coil winding technique is continuously wound on the two adjoining tooth portions. The output end of the lead wire (i.e., winding end point 71a′ on the center point side) is located axially opposite from the input end of the wire (i.e., winding start point 71b′). With this specific example too, the crossover wire portion 72a′ can be significantly reduced in length, so that an ineffective wire length can be minimized. Further, because the winding start point 71b′ and winding end point 71a′ are located in axially-opposite directions, wire connections can be located dispersedly on the opposite sides of the tooth portions, with the result that it is easy to secure a sufficient wiring space. Furthermore, because this example can provide one extra turn between the tooth portions, it can effectively increase output torque of the motor. In addition, it is possible to secure sufficient insulating spaces with the pairs of the other phases on both sides of the pair in question. Furthermore, much like the conventional winding techniques, the second example can secure sufficient insulating distances between the phases, and, when the lead wire has been wound on the tooth portion 62a′ N times (N is an arbitrary number greater than one), the second example requires no insulation in the teeth-adjoining region 70a′ since the coil windings on the tooth portions 62a′ and 62b′ are of the same phase; therefore, the second example can achieve increased, i.e. (2×N+1), turns. With the increased turn and hence increased space factor owing to the one extra turn, the second example can significantly increase the output torque of the motor. In the case where N turns are provided as above, the number of active turns can be expressed by Mathematical Expression (1) below, from which it can be seen that an increase in the number of active turns is “N/4”.
4N+1/4N=1+N/4 Mathematical Expression (1)

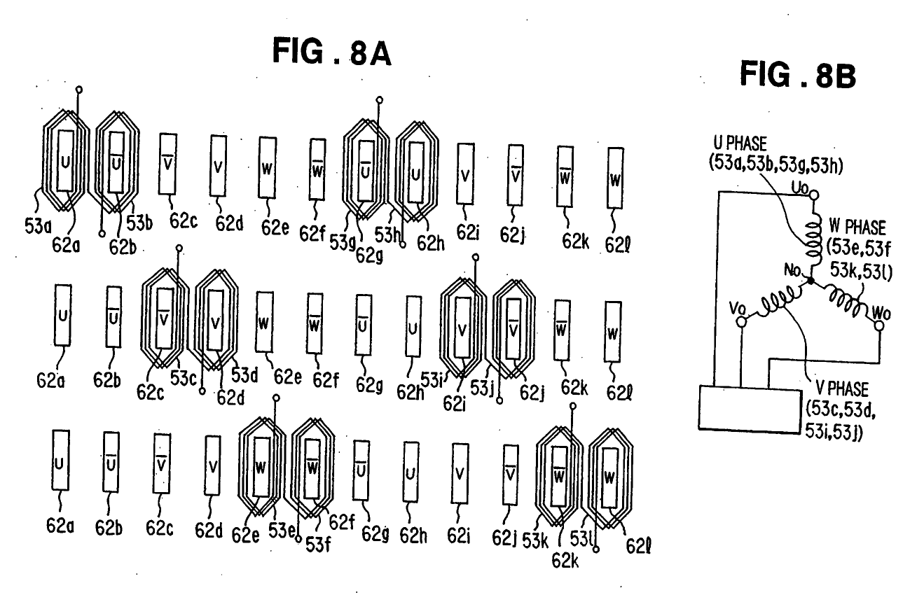

FIGS. 8A and 8B are wiring diagrams showing the coil windings in the electric motor 19 of the present invention. Specifically, FIG. 8A shows six pairs of the adjoining coil windings 62a-62l of twelve poles wound on the respective pairs of the tooth portions 62a-62l to provide three-phase (i.e., U-, V- and W-phase) winding units. Each pair of the adjoining windings is provided in accordance with the above-described first or second specific example of the inventive wire winding technique. More specifically, two pairs of the adjoining coil windings 53a, 53b and 53g, 53h are connected in series to provide the U-phase winding unit, other two pairs of the adjoining coil windings 53c, 53d and 53i, 53j are connected in series to provide the V-phase winding unit, and still other two pairs of the adjoining coil windings 53e, 53f and 53k, 53l are connected in series to provide the W-phase winding unit. As illustrated in FIG. 8B, the respective one ends Uo, Vo and Wo of the U, V and W phases are connected to a battery 36

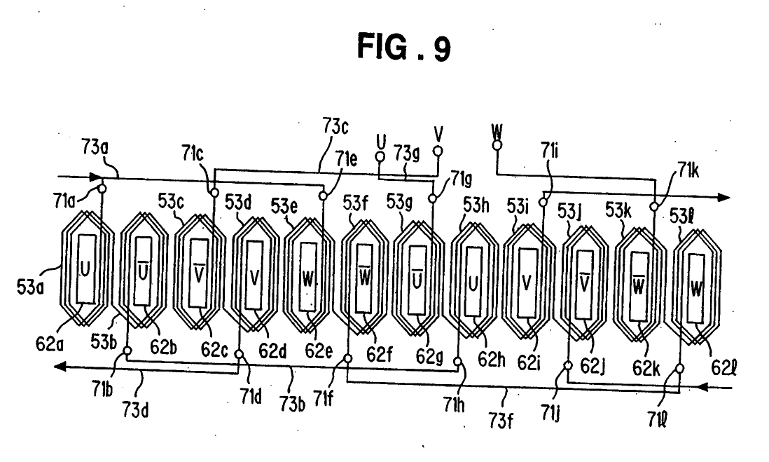

FIG. 9 is a wiring diagram showing wire connections and neutral lines of the coil windings 53a-53l. The terminal 71a of the coil winding 53a is connected, via a connecting line 73a, to a terminal 71e of the coil winding 53e and terminal 71i of the coil winding 53i. The terminal 71b of the coil winding 53b is connected, via a connecting line 73b, to a terminal 71h of the coil winding 53h. Terminal 71c of the coil winding 53c is connected via a connecting line 73c to a terminal V. Terminal 71d of the coil winding 53d is connected, via a connecting line 73d, to a terminal 71j of the coil winding 53j. Terminal 71f of the coil winding 53f is connected, via a connecting line 73f, to a terminal 71l of the coil winding 53l. Terminal 71g of the coil winding 53g is connected via a connecting line 73g to a terminal U. Further, a terminal 71k of the coil winding 53k is connected via a connecting line 73k to a terminal W.

The neutral line 73a connected to a neutral pole No (see FIG. 8B), functioning as a potential reference, is drawn to one side (upper side in the figure) of the coil windings 53a-53l, while the other connecting lines 73b, 73d and 73f are drawn to the other side (lower side in the figure) of the coil windings 53a-53l. In this way, it is possible to minimize unwanted overlapping between the wire connections, so that the wiring can be facilitated and the overall size of the electric motor can be reduced.

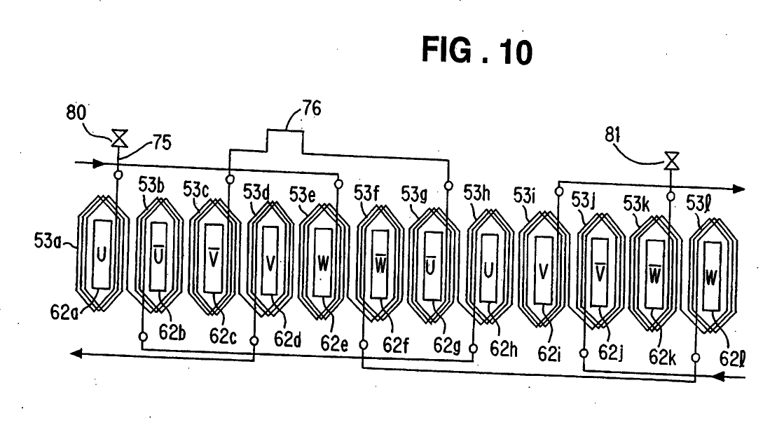

Next, a description will be given about a second embodiment of the electric motor 19 of the present invention, which employs another example of the wire winding technique. In this embodiment, a single lead wire (75 of FIG. 10) is wound on all of the twelve (i.e., all of the six pairs of) adjoining tooth portions 62a-62l. Namely, per pair of the adjoining tooth portions 62a-62l, the lead wire is wound, starting from a winding start point adjacent to one side portion (upper side portion in the figure) of the teeth-adjoining adjoining region, around one of the two adjoining tooth portions. After the lead wire has been wound on the one tooth portion a predetermined number of times (i.e., predetermined turns), it is passed through the teeth-adjoining region to adjacent to the other side portion (lower side portion in the figure) of the teeth-adjoining region and then wound around the other tooth portion the same predetermined number of times as around the one tooth portion, starting from a winding start point adjacent to the other side portion of the teeth-adjoining region axially opposite from the winding start point of the coil winding on the one tooth portion and terminating at a winding end point adjacent to the one side portion of the teeth-adjoining region. In this way, the lead wire is wound on the two tooth portions in a generally “8” configuration. The single lead wire 75 is continuously wound on all of the pairs of the tooth portions corresponding to the U, V and W phases through repetition of the above-described operations, and then the lead wire 75 is cut at is predetermined point (76 of FIG. 10).

FIG. 10 is a wiring diagram showing the coil windings in the second embodiment of the electric motor 19 shown in FIG. 9. As shown, the lead wire 75 is wound, starting from the winding start point 80, sequentially around the tooth portions 62a, 62b, 62h, 62g, 62c, 62d, 62j, 62i, 62e, 62f, 62l and 62k in the order mentioned, and thence terminates at the winding end point 81. In this way, the coil windings 53a, 53b and 53g, 53h on two pairs of the adjoining tooth portions 62a, 62b and 62g, 62h connected in series provide the U-phase winding unit, the coil windings 53c, 53d and 53i, 53j on other two pairs of the adjoining tooth portions 62c, 62d and 62i, 62j connected in series provide the V-phase winding unit, and the coil windings 53e, 53f and 53k, 53l on still other two pairs of the adjoining tooth portions 62e, 62f and 62k, 62l connected in series provide the W-phase winding unit.

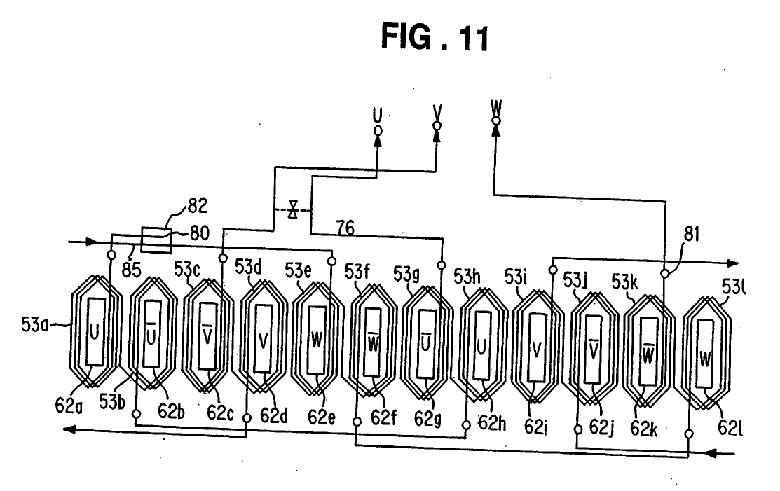

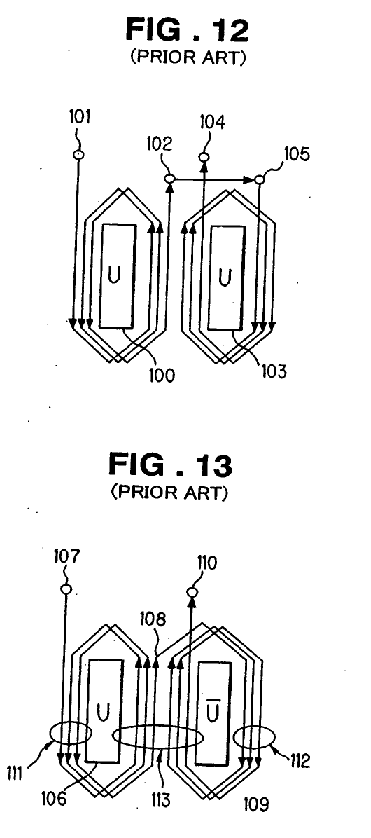

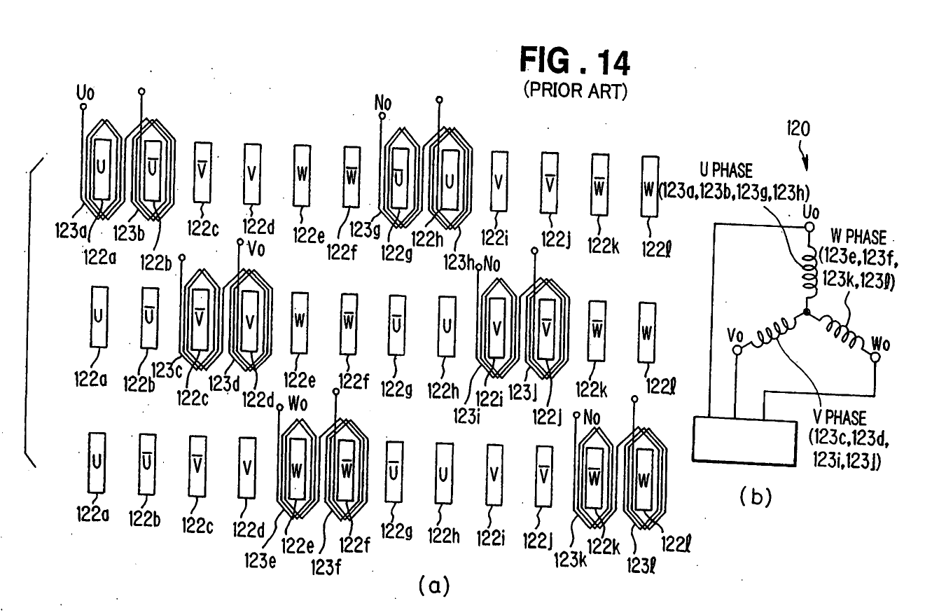

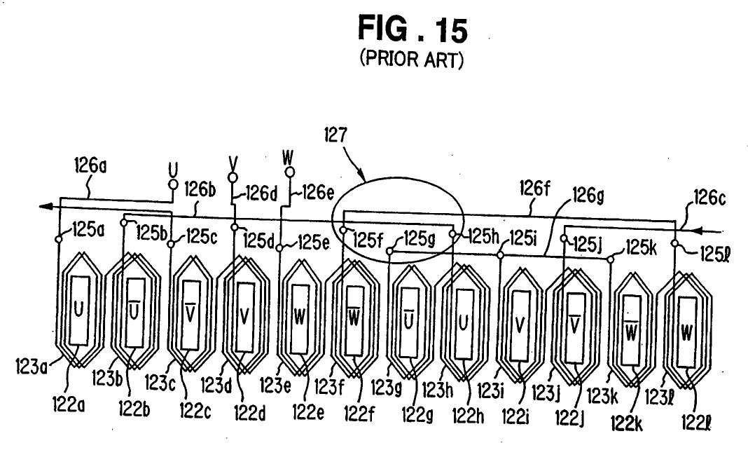

FIG. 11 is a wiring diagram showing wire connections and neutral lines of the coil windings 53a-53l. The lead wire 75 of FIG. 10 wound in the above-described manner is cut at the single point 76, and the winding start point 80 is coupled with a lead wire 85 via a wire connection conjunction 82 by fusing. Also, two ends produced by the cutting at the point 76 are connected to the terminals U and V, and the winding end point 81 is connected to the terminal W. Such arrangements allow the lead wire to be wound on the tooth portions of the U, V and W phase in a virtually concurrent fashion and thus can eliminate a need for connecting the wire to connecting lines. In this way, the instant embodiment can greatly facilitate manufacturing of the electric motor and also significantly reduce the necessary time for the manufacturing process.

Obviously, various minor changes and modifications of the present invention are possible in the light of the above teaching. It is therefore to be understood that within the scope of the appended claims the invention may be practiced otherwise than as specifically described.

1. An electric motor comprising:
a stator having a plurality of tooth portions;
a rotor provided for rotation in opposed relation to distal end surfaces of said tooth portions; and
coil windings provided on said plurality of tooth portions, said coil windings on each predetermined pair of adjoining said tooth portions being formed in an 8-like configuration by:
winding a lead wire around one of the adjoining tooth portions a predetermined number of times, starting from a point adjacent to one side portion of a teeth-adjoining region where the adjoining tooth portions face each other;
then winding the lead wire around other of the adjoining tooth portions the predetermined number of times, starting from a point adjacent to another side portion of the teeth-adjoining region that is located opposite from the one side portion of the teeth-adjoining region; and
then terminating winding of the lead wire at a point adjacent to the teeth-adjoining region.

2. An electric motor comprising:
a stator having a plurality of tooth portions;
a rotor provided for rotation in opposed relation to distal end surfaces of said tooth portions; and
coil windings provided on said plurality of tooth portions by winding a single lead wire around all of said plurality of tooth portions, said coil windings on each predetermined pair of adjoining said tooth portions being formed in an 8-like configuration by:
winding the lead wire around one of the adjoining tooth portions a predetermined number of times, starting from a point adjacent to one side portion of a teeth-adjoining region where the adjoining tooth portions face each other;
then winding the lead wire around other of the adjoining tooth portions the predetermined number of times, starting from a point adjacent to another side portion of the teeth-adjoining region that is located opposite from the one side portion of the teeth-adjoining region; and
then terminating winding of the lead wire at a point adjacent to the teeth-adjoining region,
the single lead wire being cut at a predetermined point thereof after having been continuously wound around all of the predetermined pairs of the tooth portions corresponding to a plurality of given phases.

3. An electric power steering apparatus comprising:
an electric motor for imparting steering assist force to a steering system, said electric motor being the electric motor recited in claim 1;
steering input detection means for detecting a steering input to the steering system; and
target motor current calculation means for calculating target current to be applied to said electric motor, on the basis of at least the steering input detected via said steering input detection means.

4. A wire winding method for an electric motor, said electric motor including a stator having a plurality of tooth portions and a rotor provided for rotation in opposed relation to distal end surfaces of the tooth portions, said wire winding method comprising:
a step of winding a single lead wire around each predetermined pair of adjoining said tooth portions in an 8-like configuration by:
a) winding the lead wire around one of the adjoining tooth portions a predetermined number of times, starting from a point adjacent to one side portion of a teeth-adjoining region where the adjoining tooth portions face each other;
b) then winding the lead wire around other of the adjoining tooth portions the predetermined number of times, starting from a point adjacent to another side portion of the teeth-adjoining region that is located opposite from the one side portion of the teeth-adjoining region; and
c) then terminating winding of the lead wire at a point adjacent to the teeth-adjoining region; and
a step of cutting the single lead wire at a predetermined point thereof, after the lead wire has been continuously wound around all of the predetermined pairs of the adjoining tooth portions, corresponding to a plurality of given phases, by performing said step of winding for each of the given phases.
